(19) United States
(12) Patent Application Publication
(10) Pub. No.: US 2003/0136433 A1
(43) Pub. Date: Jul. 24, 2003

(54) Vapor Vent

(76) Inventor: Dwayne A. Becknell, Barbourville, KY (US)

Correspondence Address: IPLM GROUP, P.A., POST OFFICE BOX 18455, MINNEAPOLIS, MN, 55418, US

(21) Appl. No.: 09/522,729

(22) Filed: Mar. 10, 2000

(51) Int. Cl. B08B 15/00

(52) U.S. Cl. 134/124; 134/64 R; 134/122 R; 134/131; 134/130; 134/129; 134/201

(57) ABSTRACT

A vapor vent for use with an industrial washing machine that increases heat performance of the industrial washing machine by removing vapors from outside two sets of curtain structures rather than in between the curtain structures. The design of the vapor vent is such that vapors and/or steam are extracted from the outer surface of the outer curtain structures proximate the openings of a conveyor type washer without extracting heat from the internal cavity of the housing unit. The vapor vent achieves this by being mounted externally from the vent cowl so as to suction vapors and/or steam that have escaped the outermost curtain, outer curtain structure. This is an improvement upon the old design that withdrew vapors as well as heat from within the machine because the vent is mounted into the vent cowl and has a detrimental effect on the heat performance of the machine. The present invention saves approximately 5 to 10 degrees of heat that was essentially wasted with the old design, and therefore, the present invention increases the heat performance of the industrial washing machine.

### BACKGROUND OF THE INVENTION

1. Field of the Invention

The present invention relates to a vapor vent, more particularly a vapor vent of an industrial dishwashing machine.

2. Description of the Prior Art

Vapor vents in industrial washing machines are commonly known in the art. In the prior art, some vapor vents are in the form of a conduit, which is attached to the roof of the chamber between two curtain panels of the washing machine. These vents remove water vapor, and they also remove a substantial amount of heat from the washing machine, and the heat that is removed from the washing machine must be replaced by the washing machine in order for it to function properly.

U.S. Pat. Nos. 2,250,238; 5,103,846; and 5,240,018 show elongated washing or cleaning installations with vapor receiving assemblies at either end, but none of these shows the structure of the subject invention. U.S. Pat. No. 2,250,238 by Smith discloses an industrial washing machine having a vent hood extending from the forward upper end of the casing and extruding over the loading end of the conveyor for carrying off any heat or vapors emitting from the entrance of the casing. Finally, U.S. Pat. Nos. 5,103,846 and 5,240,018 by Clark et al. disclose apparatus for cleaning mechanical devices using terpene compounds, which include hoods disposed around an inlet and an outlet, a fan, and a baffle. The ducts of the fan are disposed above the top sprayers and the conveyor, and the ducts are closely adjacent the inlet and the outlet. The baffle is disposed around each of the openings and extends across the width of the conveyor, and the baffle includes a narrow slotted opening that evenly draws air from across the width of the conveyor. Again, these do not show the structure of the subject invention.

### SUMMARY OF THE INVENTION

The present invention relates to a vapor vent, more particularly a vapor vent of an industrial dishwashing machine. In a preferred embodiment, a vapor exhaust system comprises a dishwasher having a housing unit and a vent. The housing unit includes at least one end having a top portion, a bottom portion, and an opening. A conveyor belt is positioned along the bottom portion of the end and extends through the housing unit. A curtain structure is suspended from the top portion of the end of the housing unit, and the curtain structure includes a top and an outer surface. The vent includes a housing having an inlet and an outlet, and the inlet and the outlet are positioned proximate the top of the curtain structure and outside the curtain structure. A conduit connects a vacuum source to the outlet of the vent, wherein the inlet removes vapors that have escaped past the outer surface of the curtain structure.

Another preferred embodiment comprises a vapor vent for use with a dishwasher including a housing unit and at least one curtain structure. The housing unit of the dishwasher includes at least one end with a top portion and a bottom portion. The end includes an opening, and the curtain structure has a top and an outer surface, the top being suspended from the top portion of the end. A conveyor belt is positioned along the bottom portion of the end and extends through the housing unit. The vapor vent comprises a housing with an inlet and an outlet, wherein the inlet receives vapor from the outer surface of the curtain structure and the outlet releases vapor in an upward direction proximate the top of the curtain structure. A conduit interconnects the vapor vent and the vacuum source, wherein the inlet removes vapors that have escaped past the outer surface of the curtain structure.

In another preferred embodiment, a vapor exhaust system comprises a dishwasher having a housing unit. The housing unit includes at least one end with a top portion, a bottom portion, and an opening. A conveyor assembly is positioned along the bottom portion of the end and extends through the opening of the housing unit. At least one curtain is suspended from the top portion of the end, and the curtain includes an outer surface. A vent is positioned proximate the opening of the housing unit and a vacuum source is positioned outside the dishwasher. The vent has an inlet and an outlet. The inlet receives vapor from the outer surface of the curtain and the outlet releases vapor to a conduit. The conduit connects the vent to the vacuum source wherein the inlet removes vapors that have escaped past the outer surface of the curtain structure.

Finally, another preferred embodiment comprises a method of removing vapors from a dishwasher having a housing unit and at least one curtain structure. The housing unit includes at least one end with a top portion, a bottom portion, and an opening. The curtain structure has a top and an outer surface, and the top is suspended from the top portion of the end. A conveyor belt is positioned along the bottom portion of the end and extends through the housing unit. The method of removing vapors comprises the steps of placing a vent exhaust system having an inlet and an outlet proximate the top of the curtain structure, and removing vapors from the outer surface of the curtain structure by using a vacuum source having connecting means to the vent exhaust system to channel the vapors into the vent exhaust system through the inlet and releasing the vapors through the outlet.

### BRIEF DESCRIPTION OF THE DRAWINGS

FIG. 1 is a perspective view of a preferred embodiment vapor vent and industrial washing machine constructed according to the principles of the present invention.

FIG. 2 is a side view of the vapor vent and the industrial washing machine shown in FIG. 1.

FIG. 3 is a perspective view of a preferred embodiment vapor vent constructed according to the principles of the present invention.

FIG. 4 is a top view of the vapor vent shown in FIG. 3.

FIG. 5 is a rear view of the vapor vent shown in FIG. 3.

FIG. 6 is a side view of the vapor vent shown in FIG. 3.

### DETAILED DESCRIPTION OF THE PREFERRED EMBODIMENT

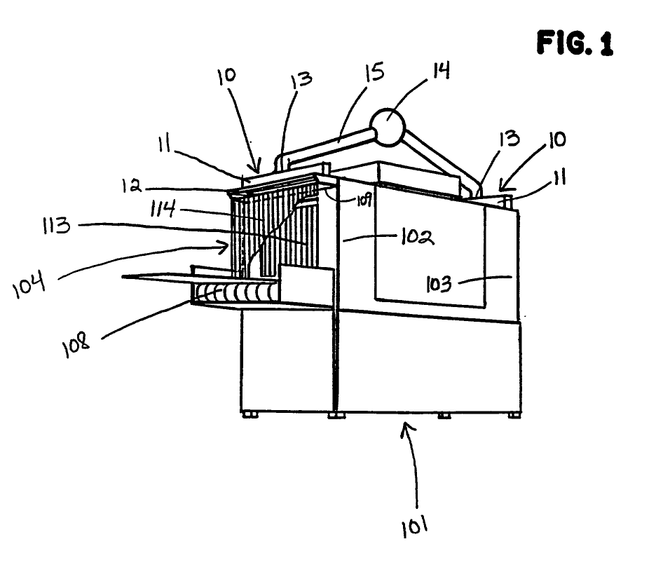

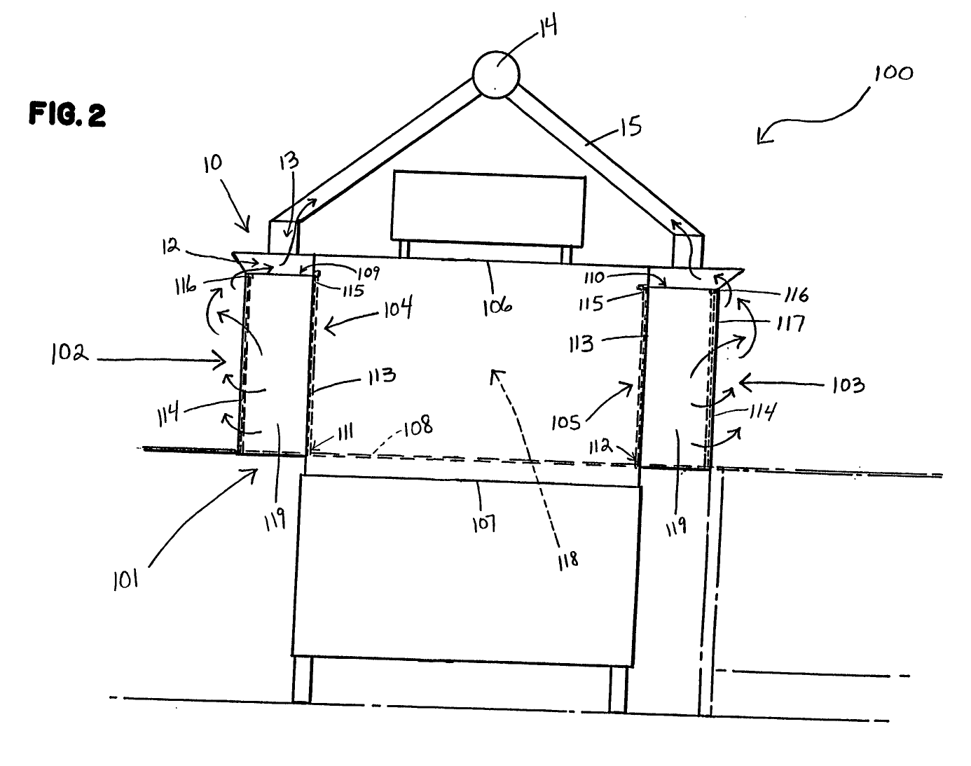

A preferred embodiment vapor vent constructed according to the principles of the present invention is designated as 10 in FIGS. 1-6, and a preferred embodiment industrial washing machine constructed according to the principles of the present invention is designated as 100 in FIGS. 1-2.

Industrial washing machine 100, of the type herein referred, is adapted for washing a multitude of various size and shape objects. The objects are conveyed through industrial washing machine 100 by a suitable type conveyor belt 108 for continuous operation and handling of a large volume of objects. The operation of industrial washing machine 100 being continuous, the objects are received into industrial washing machine 100 on conveyor belt 108 at first end 102 and delivered by conveyor belt 108 from an opposite end, second end 103, clean and dry and ready for reuse. In the present instance, for the purpose of exemplification, the description of industrial washing machine 100 will be confined to its use with vapor vent 10.

FIGS. 1 and 2 show a preferred embodiment vapor vent 10 connected to an industrial washing machine 100. Industrial washing machine 100 is generally in the form of a housing unit 101. Housing unit 101 includes first end 102, second end 103, top portion 106, and bottom portion 107, which define cavity 118. Cavity 118 provides an area in which the objects are washed, rinsed and dried within housing unit 101. Washing rinsing, and drying are most effectively achieved by using hot water and hot air blasts, heated in any suitable manner, as for example, by a plurality of gas burners disposed beneath conveyor 108 in its forward course. During the drying cycle, for example, heated air is drawn from a rearward end of the drying area, preferably by a rotary or centrifugal blower, for forcible delivery to and discharge from a transverse row of nozzles onto the conveyor transported objects, and also to provide for forcible and continuous circulation of the air through the drying area. It is understood that any suitable manner may be employed to wash, rinse, and dry the objects using heat. It is also understood that any suitable washing machine 100 may be utilized with vent 10.

First end 102 of housing unit 101 includes opening 104 having top surface 109 and bottom surface 111, and second end 103 includes opening 105 having top surface 110 and bottom surface 112. Bottom surfaces 111 and 112 provide surfaces on which conveyor belt 108 is attached. Conveyor belt 108 moves objects in and out of housing unit 101 through openings 104 and 105, respectively. Any suitable type of conveyor known in the art may be used. Top surfaces 109 and 110 provide surfaces on which top 115 of inner curtain structure 113 and top 116 of outer curtain structure 114 are suspended. Curtain structures 113 and 114 are suspended by hooks attached to top surfaces 109 and 110. Tops 115 and 116 of curtain structures 113 and 114 each loop around a rod member, which is supported by the hooks on top surfaces 109 and 110. However, it is understood that any means known in the art to suspend curtain structures 113 and 114 may be used.

Curtain structures 113 and 114 are made from a material that allows objects to pass through easily but forms somewhat of a barrier to prevent steam and heat from escaping out of housing unit 101. In the preferred embodiment, the material is a flexible sheet having a plurality of vertical slits extending from proximate tops 115 and 116 of curtain structures 113 and 114 all the way to the bottom of curtain structures 113 and 114. Curtain structures 113 and 114 may be made of a flexible plastic, fabric, or rubber, although any suitable material known in the art that would allow passage and form somewhat of a barrier could be utilized. These curtain structures 113 and 114 are spaced apart to define a chamber 119. Outer curtain structure 114 includes an outer surface 117, which is the surface of outer curtain structure 114 that is exposed to the external environment of industrial washing machine 100. In the prior art, a vent in the form of a conduit is attached to the roof of the chamber between the two curtain structures, and the vent removes steam along with a substantial amount of heat from the washing machine. In the subject invention, vapor vents 10 are located on the top surfaces 109 and 110 of openings 104 and 105, respectively, proximate chambers 119. Rather than removing steam and heat from in between curtain structures 113 and 114, vapor vent 10 removes steam and heat proximate outer surface 117 of outer curtain structure 114 that has escaped both sets of curtain structures 113 and 114. The flow of vapors, such as steam and heat, from outer surface 117 to vent 10 is shown by arrows in FIG. 2.

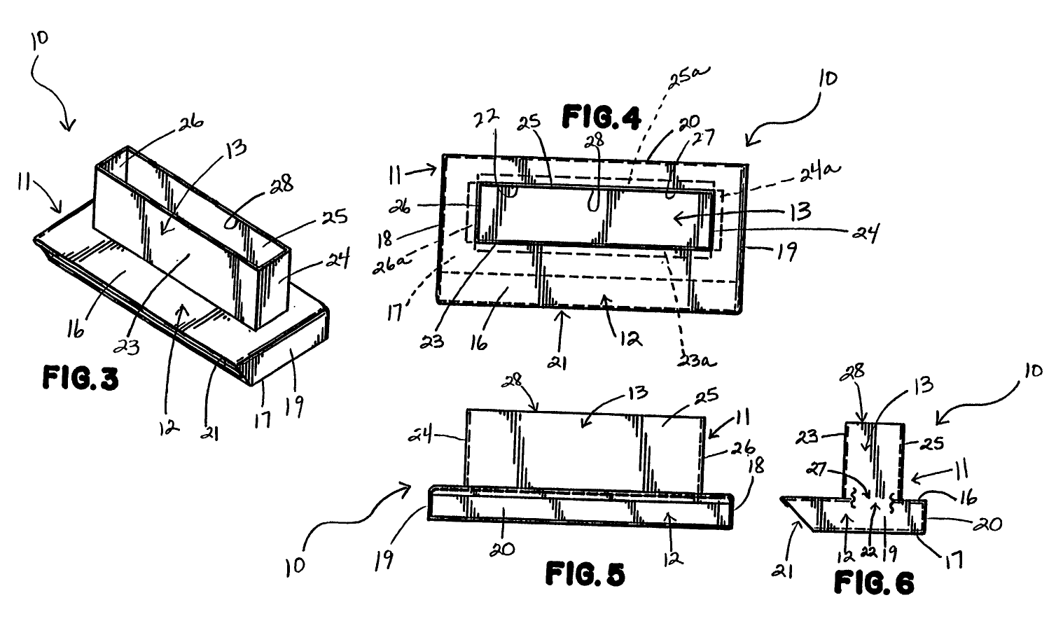

FIGS. 3-6 show the preferred embodiment vapor vents 10 in greater detail. Vapor vents 10 include housing 11 having an inlet 12 and an outlet 13. Inlet 12 is a rectangular shaped box with a hollow cavity, which is defined by top 16, bottom 17, first side 18, second side 19, and back 20. Inlet 12 is in a horizontal orientation with respect to washing machine 100. Top 16, bottom 17, first side 18, and second side 19 form first opening 21, which is angled in a downward orientation in order to maximize the amount of vapor received by inlet 12 proximate outer surface 117. Therefore, top 16 is the same length but wider than bottom 17, and first side 18 and second side 19 have an angled edge to accommodate the difference in width between top 16 and bottom 17. This creates the downward orientation of opening 21. Top 16 also includes second opening 22, which is configured and arranged to be in direct communication with first opening 27 and second opening 28 of outlet 13. Therefore, vapors are drawn into first opening 21, out of second opening 22, and into first opening 27 of outlet 13.

Outlet 13 is a rectangular shaped box with a hollow cavity, which is defined by first side 23, second side 24, third side 25, and fourth side 26. Outlet 13 is in a vertical orientation with respect to inlet 12 and washing machine 100. Sides 23 and 25 are opposing sides of the same size, and sides 24 and 26 are opposing sides of the same size. Furthermore, sides 23-26 define first opening 27 and second opening 28, which lead into and out of the hollow cavity within outlet 13, respectively. In addition, side 23 includes tab 23a, side 24 includes tab 24a, side 25 includes tab 25a, and side 26 includes tab 26a. Tabs 23a-26a are proximate first opening 27 and attach outlet 13 to inlet 12 proximate second opening 22 by any suitable manner of attachment, such as welding. Therefore, tabs 23a-26a are attached to inlet 12 so as to provide direct communication between inlet 12 and outlet 13. Second opening 22 of inlet 12 and first opening 27 and second opening 28 of outlet 13 are approximately the same size and are in direct communication with one another. In FIG. 6, top 16 is broken away to show second opening 22 of inlet 12 and first opening 27 of outlet 13.

Attached to outlet 13 and contiguous with second opening 28 is conduit 15. Vacuum source 14, which is operatively connected to outlet 13 by conduit 15, is the means by which vapor flows into inlet 12 through housing 11 and out of outlet 13. Conduit 15 may be made of metal, hose, or any other suitable material. First, inlet 12 takes in vapors through first opening 21 that have escaped from both inner curtain structure 113 and outer curtain structure 114, proximate outer surface 117 of outer curtain structure 114. Then, the vapors are drawn through second opening 22 into first opening 27 of outlet 13, where the vapors are drawn out of second opening 28, into conduit 15, and toward vacuum source 14. As a result, vapors are effectively removed from the outer surface 117 of outer curtain structure 114. Therefore, steam and heat that have escaped from outer curtain structure 114 are pulled into this vent plenum, thereby reducing the amount of heat withdrawn from inside industrial washing machine 100. The subject invention can save approximately five to ten degrees of heat that would be lost in the prior art device.

The design of vapor vent 10 is such that vapors and/or steam are extracted from outer surface 117 of outer curtain structures 114 proximate openings 104 and 105 of a conveyor type washer without extracting heat from the internal cavity 118 of the housing unit 101. Vapor vent 10 achieves this by being mounted externally from the vent cowl so as to suction vapors and/or steam that have escaped the outermost curtain, outer curtain structure 114. This is an improvement upon the old design that withdrew vapors as well as heat from within the machine because the vent is mounted into the vent cowl and has a detrimental effect on the heat performance of the machine. The present invention saves approximately 5 to 10 degrees of heat that was essentially wasted with the old design, and therefore, the present invention increases the heat performance of industrial washing machine 100.

The above specification, examples and data provide a complete description of the manufacture and use of the composition of the invention. Since many embodiments of the invention can be made without departing from the spirit and scope of the invention, the invention resides in the claims hereinafter appended.

I claim:

1. A vapor exhaust system, comprising:
a. a dishwasher having a housing unit, said housing unit including at least one end, said end having a top portion and a bottom portion and said end including an opening;
b. a conveyor belt positioned along said bottom portion of said end and extending through said housing unit;
c. a curtain structure suspended from said top portion of said end, said curtain structure having a top and an outer surface;
d. a vent including a housing having an inlet and an outlet, said inlet and said outlet being positioned proximate said top of said curtain structure and being positioned outside the curtain structure;
e. a vacuum source; and
f. a conduit connecting said outlet of said vent to said vacuum source, wherein said inlet removes vapors that have escaped past said outer surface of said curtain structure.

2. The vapor exhaust system of claim 1, wherein said curtain structure comprises a flexible sheet having a plurality of vertical slits extending from proximate said top of said curtain structure all the way to a bottom of said curtain structure.

3. The vapor exhaust system of claim 2, wherein said housing unit includes a first end with an opening and a second end with an opening, and wherein said conveyor belt enters said housing unit through said first end and exits said housing unit through said second end.

4. The vapor exhaust system of claim 3, wherein said curtain structure comprises an inner curtain structure with a top and an outer curtain structure with a top, said inner curtain structure and said outer curtain structure being suspended by said top from said top portion of said end.

5. The vapor exhaust system of claim 4, wherein said outer curtain structure includes an outer surface and wherein said inlet receives vapor from said outer surface of said outer curtain structure.

6. The vapor exhaust system of claim 5, wherein said outlet releases vapor in an upward direction proximate said top of said curtain structure.

7. A vapor vent for use with a dishwasher having a housing unit and at least one curtain structure, the housing unit including at least one end with a top portion and a bottom portion, the end including an opening, the curtain structure having a top and an outer surface, the curtain structure being suspended from the top portion of the end by the top of the curtain structure, and a conveyor belt positioned along the bottom portion of the end and extending through the housing unit, comprising:
a. a housing around said vapor vent with an inlet and an outlet, said inlet receiving vapor from said outer surface of said curtain structure, and said outlet releasing vapor in an upward direction proximate said top of said curtain structure;
b. a vacuum source; and
c. a conduit interconnected between said vapor vent and said vacuum source, wherein said inlet removes vapors that have escaped past said outer surface of said curtain structure.

8. The vapor vent of claim 7, wherein said curtain structure comprises a flexible sheet having a plurality of vertical slits extending from proximate said top of said curtain structure all the way to a bottom of said curtain structure.

9. The vapor vent of claim 8, wherein said curtain structure further comprises an inner curtain structure and an outer curtain structure, said inner curtain structure and said outer curtain structure having a top and being suspended by said top from said top portion of said end.

10. The vapor vent of claim 9, wherein said housing unit has a first opening and a second opening, and wherein said conveyor belt enters said housing unit through said first opening and exits said housing unit through said second opening.

11. A vapor exhaust system, comprising:
a. a dishwasher having a housing unit, said housing unit having at least one end with a top portion, a bottom portion and an opening;
b. a conveyor assembly positioned along said bottom portion of said end and extending through said opening and said housing unit;
c. at least one curtain suspended from said top portion of said end, said curtain having an outer surface; and
d. a vent being positioned proximate said opening of said housing unit and a vacuum source being positioned outside said dishwasher, said vent having an inlet and an outlet, said inlet receiving vapor from said outer surface of said curtain, and said outlet releasing vapor to a conduit, said conduit connecting said vent to said vacuum source, wherein said inlet removes vapors that have escaped past said outer surface of said curtain structure.

12. The vapor vent of claim 11, wherein said curtain structure comprises a flexible sheet having a plurality of vertical slits extending from proximate said top of said curtain structure all the way to a bottom of said curtain structure.

13. The vapor vent of claim 12, wherein an inner curtain and an outer curtain have a top and are suspended by said top from said top portion of said end of said housing unit.

14. The vapor vent of claim 13, wherein said conveyor belt enters said housing unit through a first opening and exits said housing unit through a second opening.

15. A method of removing vapors from a dishwasher having a housing unit and at least one curtain structure, the housing unit including at least one end with a top portion and a bottom portion, the end including an opening, the curtain structure having a top and an outer surface, the curtain structure being suspended from the top portion of the end by the top of the curtain structure, and a conveyor belt positioned along the bottom portion of the end and extending through the housing unit, comprising the steps of:
a. placing a vent exhaust system proximate said top of said curtain structure, said vent exhaust system including an inlet and an outlet; and
b. removing vapors from said outer surface of said curtain structure by using a vacuum source operatively connected to said vent exhaust system to channel said vapors into said vent exhaust system through said inlet and releasing said vapors through said outlet.
